(19) United States
(12) Patent Application Publication
(10) Pub. No.: US 2019/0304355 A1
(43) Pub. Date: Oct. 3, 2019

(54) METHOD FOR DRIVING DISPLAY DEVICE

(71) Applicants: HKC Corporation Limited, Shuitian Village, Shiyan Sub-district (CN); Chongqing HKC Optoelectronics Technology Co., Ltd., Chongqing (CN)

(72) Inventor: Chih-Tsung KANG, Chongqing (CN)

(21) Appl. No.: 16/064,406

(22) PCT Filed: Jan. 23, 2018
(86) PCT No.: PCT/CN2018/073764

§ 371 Date: Jun. 20, 2018

(30) Foreign Application Priority Data
Dec. 21, 2017 (CN) 201711395434.6

(51) Int. Cl. G09G 3/20; G09G 3/36

(52) U.S. Cl. CPC G09G 3/2074; G09G 3/3648; G09G 2340/0457; G09G 2300/0452; G09G 3/3607

(57) ABSTRACT

This application relates to a method for driving a display device. The method for driving a display device includes: calculating input signals of all sub-pixel units in a display area, and dividing the input signals into three frame signals; defining a frame combination according to grayscale signals of a red pixel unit, a green pixel unit, and a blue pixel unit; increasing a main tone luminance at a side viewing angle according to the three frame signals; increasing a ratio of a main tone luminance of a main sub-pixel; and adjusting a main signal luminance at the side viewing angle.

### BACKGROUND

### Technical Field

This application relates to a method for designing a display panel, and in particular, to a method for driving a display device.

### Related Art

A liquid-crystal display (LCD) is a flat thin display device, includes a quantity of color or black and white pixels, and is disposed in front of a light source or a reflecting surface. Each pixel includes the following parts: a liquid crystal molecular layer suspending between two transparent electrodes, and two polarization filters, with polarization directions perpendicular to each other, disposed on two outer sides. If there is no liquid crystal between electrodes, when light passes through one of the polarization filters, a polarization direction of the light is completely perpendicular to that of the second polarization filter. Therefore, the light is completely blocked. However, if the polarization direction of the light passing through one of the polarization filters is rotated by a liquid crystal, the light can pass through the other polarization filter. Rotation of the polarization direction of the light by the liquid crystal may be controlled by using an electrostatic field, so as to control the light.

Before charges are applied to transparent electrodes, arrangement of liquid crystal molecules is determined by arrangement on surfaces of the electrodes. Surfaces of chemical substances of the electrodes may be used as seeds of crystals. In a most common twisted nematic (TN) liquid crystal, two electrodes above and below the liquid crystal are vertically arranged. Liquid crystal molecules are arranged in a spiral manner. A polarization direction of light passing through one polarization filter rotates after the light passes through a liquid crystal sheet, so that the light can pass through the other polarization filter. In this process, a small part of light is blocked by the polarization filter, and looks gray when being seen from outside. After the charges are applied to the transparent electrodes, the liquid crystal molecules are almost completely arranged in parallel along an electric field direction. Therefore, a polarization direction of light passing through one of the polarization filters does not rotate. Therefore, the light is completely blocked. In this case, a pixel looks black. A twisting degree of arrangement of the liquid crystal molecules can be controlled by means of voltage control, so as to achieve different grayscales.

Because the liquid crystal itself is colorless, a color filter is used to generate various colors, and is a key component for turning a grayscale LCD into a color LCD. A backlight module in the LCD provides a light source, then grayscale display is formed by means of a drive IC and liquid crystal control, and the light source passes through a color photoresist layer of the color filter to form a color display image.

### SUMMARY

To resolve the foregoing technical problem, an objective of this application is to provide a method for designing a display panel, and in particular, a method for driving a display device, including: calculating an input signal of a sub-pixel unit in a display area, and dividing the input signal into three frame signals; defining a frame combination according to grayscale signals of a first pixel unit, a second pixel unit, and a third pixel unit; increasing a main tone luminance at a side viewing angle according to the three frame signals; increasing a ratio of a main tone luminance of a main sub-pixel; and adjusting a main signal luminance at the side viewing angle.

To achieve the objective of this application and resolve technical problems of this application, the following technical solutions are used. A method for driving a display device provided in this application includes: calculating an input signal of a sub-pixel unit in a display area, and dividing the input signal into three frame signals; defining a frame combination according to grayscale signals of a first pixel unit, a second pixel unit, and a third pixel unit; increasing a main tone luminance at a side viewing angle according to the three frame signals; increasing a ratio of a main tone luminance of a main sub-pixel; and adjusting a main signal luminance at the side viewing angle.

To further achieve the objective of this application and resolve technical problems of this application, the following technical measures may be taken.

Another objective of this application is to provide a method for driving a display device. The method includes: calculating an input signal of a sub-pixel unit in a display area, and dividing the input signal into three frame signals; defining a frame combination according to grayscale signals of a first pixel unit, a second pixel unit, and a third pixel unit; increasing a main tone luminance at a side viewing angle according to the three frame signals; increasing a ratio of a main tone luminance of a main sub-pixel; and adjusting a main signal luminance at the side viewing angle. Regarding the defining a frame combination according to grayscale signals of a first pixel unit, a second pixel unit, and a third pixel unit, when first hues of the first pixel unit, the second pixel unit, and the third pixel unit are combined, and a signal of the first pixel unit is greater than a signal of the second pixel unit, and the signal of the second pixel unit is greater than a signal of the third pixel unit, a minimum common signal of the first pixel unit, the second pixel unit, and the third pixel unit is the third pixel unit. Therefore, the grayscale signals of the first pixel unit, the second pixel unit, and the third pixel unit are changed into three frame combinations. The three frame combinations are respectively a combination 1 of a first first pixel unit, a first second pixel unit, and a first third pixel unit, a combination 2 of a second first pixel unit, a second second pixel unit, and a second third pixel unit, and a combination 3 of a third first pixel unit, a third second pixel unit, and a third third pixel unit. An original sub-pixel signal is changed from the first pixel unit, the second pixel unit, and the third pixel unit into a combination of three frame signals, and the combination of the three signals is presented in a time sequence, that is, an original frame signal needs to be tripled. At one time, the combination 1 of the first first pixel unit, the first second pixel unit, and the first third pixel unit is presented. At another time, the combination 2 of the second first pixel unit, the second second pixel unit, and the second third pixel unit is presented. At still another time, the combination 3 of the third first pixel unit, the third second pixel unit, and the third third pixel unit is presented.

In an embodiment of this application, an input signal of a sub-pixel unit in a display area is calculated and is divided into three frame signals, where the three frame signals are respectively a minimum common signal frame, a second single color frame, and a third single color frame.

In an embodiment of this application, regarding the defining a frame combination according to grayscale signals of a first pixel unit, a second pixel unit, and a third pixel unit, when first hues of the first pixel unit, the second pixel unit, and the third pixel unit are combined, and a signal of the first pixel unit is greater than a signal of the second pixel unit, and the signal of the second pixel unit is greater than a signal of the third pixel unit, a minimum common signal of the first pixel unit, the second pixel unit, and the third pixel unit is the third pixel unit. Therefore, the grayscale signals of the first pixel unit, the second pixel unit, and the third pixel unit are changed into three frame combinations. The three frame combinations are respectively a combination 1 of a first first pixel unit, a first second pixel unit, and a first third pixel unit, a combination 2 of a second first pixel unit, a second second pixel unit, and a second third pixel unit, and a combination 3 of a third first pixel unit, a third second pixel unit, and a third third pixel unit.

In an embodiment of this application, a minimum common signal of the combination 1 of the first first pixel unit, the first second pixel unit, and the first third pixel unit is the third pixel unit, that is, the first first pixel unit=the third pixel unit, the first second pixel unit−the third pixel unit, and the first third pixel unit=the third pixel unit.

In an embodiment of this application, the combination 2 of the second first pixel unit, the second second pixel unit, and the second third pixel unit is one color of two remaining color signals obtained according to a difference between an original signal and the combination 1, satisfying that the second first pixel unit=the first pixel unit−the third pixel unit, the second second pixel unit=0, and the second third pixel unit=0 or the second first pixel unit=0, the second second pixel unit=the second pixel unit−the third pixel unit, and the second third pixel unit=0.

In an embodiment of this application, the combination 3 of the third first pixel unit, the third second pixel unit, and the third third pixel unit is a last remaining signal color, satisfying that the third first pixel unit=0, the third second pixel unit=the second pixel unit−the third pixel unit, and the third third pixel unit=0 or the third first pixel unit=the first pixel unit−the third pixel unit, the third second pixel unit=0, and the third third pixel unit=0.

In an embodiment of this application, dividing an original frame signal into a combination of three frame signals is performed by dividing a high-voltage sub-pixel signal into two low-voltage combinations.

In an embodiment of this application, the two low-voltage combinations keep a front viewing angle luminance of an original sub-pixel unchanged, and the main tone luminance at the side viewing angle is increased because a sum of two low-voltage side viewing angle luminances is greater relative to an original high-voltage side viewing angle luminance.

In an embodiment of this application, the increased ratio of the main tone luminance of the main sub sub-pixel is a ratio relative to a side viewing angle luminance of an original frame low-voltage sub-pixel.

In this application, by means of determining signals of first, second, and third sub-pixel combinations, first, second, and third sub-pixel input signals in each group are divided into three frame signals for presentation, and in cooperation with the presentation, a drive frequency of a display needs to be tripled to separately display the three frame signals obtained by means of division. The three frame signals are respectively a minimum common signal frame, a second single color frame, and a third single color frame. The three frame signals obtained by means of division increase a luminance of a main tone at a side viewing angle, and increase a ratio of a main tone of the main sub-pixel relative to a side viewing angle luminance of an original frame low-voltage sub-pixel, so that a color cast situation, affected by the low-voltage sub-pixel, of the main tone at the side viewing angle is improved. Alleviation of a viewing angle color cast problem is ensured, and presentation of a main signal luminance at the side viewing angle is enhanced. A backlight luminance is enhanced to be three times of an original luminance, and therefore, a luminance of display of the first, the second, and the third sub-pixel combinations and overall image quality remain unchanged.

### BRIEF DESCRIPTION OF THE DRAWINGS

FIG. 1 is a diagram of a relationship between a color system and a color cast of an exemplary LCD before color cast adjustment;

FIG. 2 is a diagram of a relationship between a red color cast and a grayscale of an LCD before color cast adjustment according to an embodiment of this application;

FIG. 3 is a diagram of a relationship between a green color cast and a grayscale of an LCD before color cast adjustment according to an embodiment of this application;

FIG. 4 is a diagram of a relationship between a blue color cast and a grayscale of an LCD before color cast adjustment according to an embodiment of this application;

FIG. 5 is a diagram of a relationship between red X, green Y, and blue Z of red, green, and blue at a front viewing angle and a grayscale of an LCD before color cast adjustment according to an embodiment of this application;

FIG. 6 is a diagram of a relationship between red X, green Y, and blue Z of red, green, and blue at a large viewing angle and a grayscale of an LCD before color cast adjustment according to an embodiment of this application; and

FIG. 7 is a flowchart of a method for driving a display device according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures taken in this application to achieve the intended application objective and effects thereof, specific implementations, structures, features, and effects of a method for driving a display device provided according to this application are described below in detail with reference to the drawings and preferred embodiments.

A display device of this application includes a display panel and a backlight module disposed opposite to each other. The display panel mainly includes a color filter substrate, an active array substrate, and a liquid crystal layer sandwiched between the two substrates. The color filter substrate, the active array substrate, and the liquid crystal layer may form a plurality of pixel units arranged in an array. The backlight module may emit light rays penetrating through the display panel, and display colors by using pixel units of the display panel, to form an image.

In an embodiment, the display panel of this application may be a curved-surface display panel, and the display device of this application may also be a curved-surface display device.

Currently, in improvement of a wide viewing angle technology of a vertical alignment (VA) display panel, manufacturers of display devices have developed a photo-alignment technology to control an alignment direction of liquid crystal molecules, thereby improving optical performance and a yield of a display panel. In the photo-alignment technology, multi-domain alignment is formed in each pixel unit of a panel, so that liquid crystal molecules in a pixel unit tilt towards, for example, four different directions. In the photo-alignment technology, a polymer thin film (an alignment layer) of a color filter substrate or a thin film transistor substrate is irradiated by using an ultraviolet light source (for example, polarized light), so that non-homogeneous photopolymerization, isomerization, or pyrolysis occurs in polymer structures on a surface of the thin film, inducing chemical bond structures on the surface of the thin film to generate special directivities, so as to further induce forward arrangement of liquid crystal molecules, thereby performing photo-alignment.

According to different orientation manners of liquid crystals, currently, display panels on a mainstream market may be classified into the following types: a VA type, a TN or a super twisted nematic (STN) type, an in-plane switching (IPS) type, and a fringe field switching (FFS) type. Displays of a VA mode include, for example, a patterned vertical alignment (PVA) display or a multi-domain vertical alignment (MVA) display device. The PVA display achieves a wide viewing angle effect by using a fringe field effect and a compensation plate. In the MVA display device, one pixel is divided into a plurality of areas, and a protrusion or a particular pattern structure is used, so that liquid crystal molecules in different areas tilt towards different directions, to achieve a wide viewing angle and increase a penetration rate. In an IPS mode or an FFS mode, by applying an electric field including components approximately parallel to a substrate, liquid crystal molecules make responses in a direction parallel to a plane of the substrate and are driven. An IPS display panel and an FFS display panel have advantages of wide viewing angles.

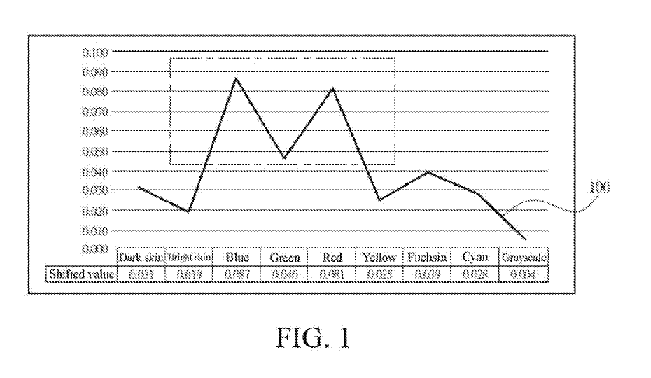

FIG. 1 is a diagram of a relationship between a color system and a color cast of an exemplary LCD before color cast adjustment. Referring to FIG. 1, in an LCD, due to a correlation between a refractive index and a wavelength, penetration rates of different wavelengths are related to phase delays of different wavelengths, so that penetration rates and wavelengths have performance of different degrees. In addition, with drive of a voltage, phase delays of different wavelengths also generate changes of different degrees, affecting performance of penetration rates of different wavelengths. FIG. 1 shows changes of color casts of large viewing angles and front viewing angles of various representative color systems of the LCD. It can be obviously found that situations of color casts 100 of large viewing angles of color systems of red, green, and blue hues are all more severe than those of other color systems. Therefore, overcoming color cast defects of the red, green, and blue hues can greatly improve an overall color cast of a large viewing angle.

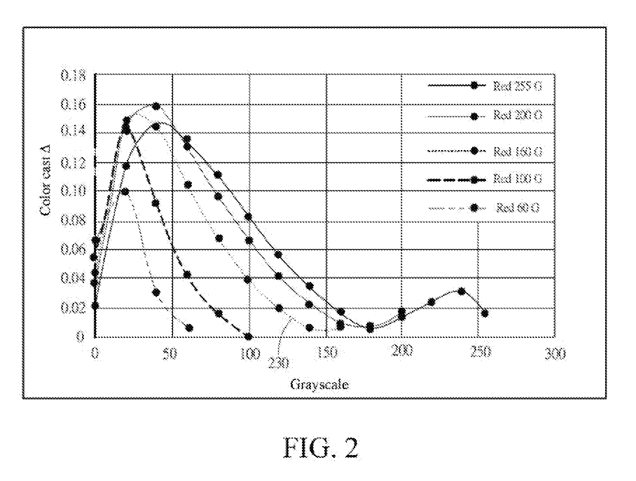

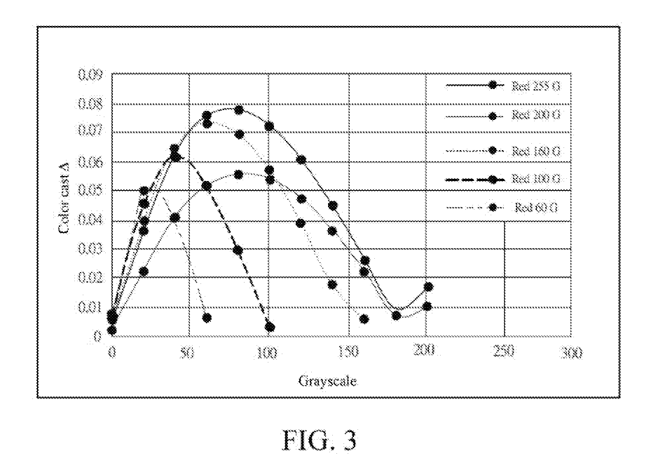

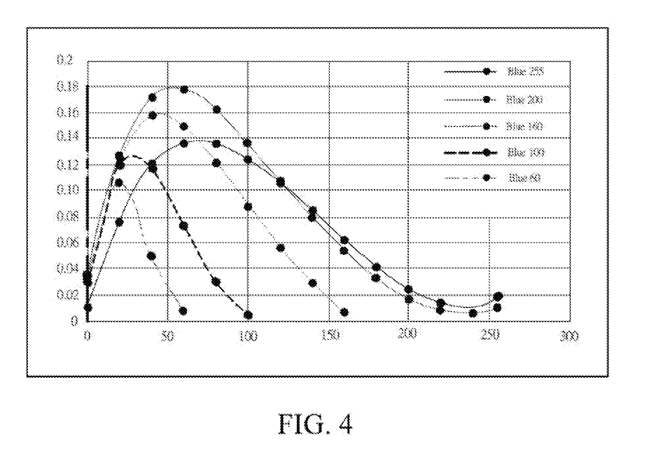

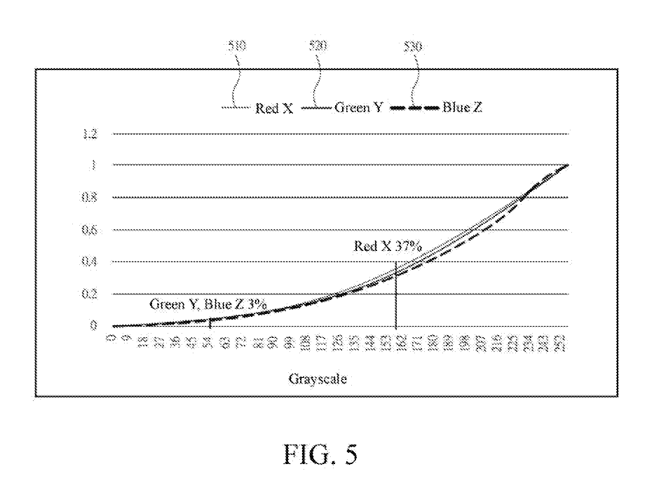

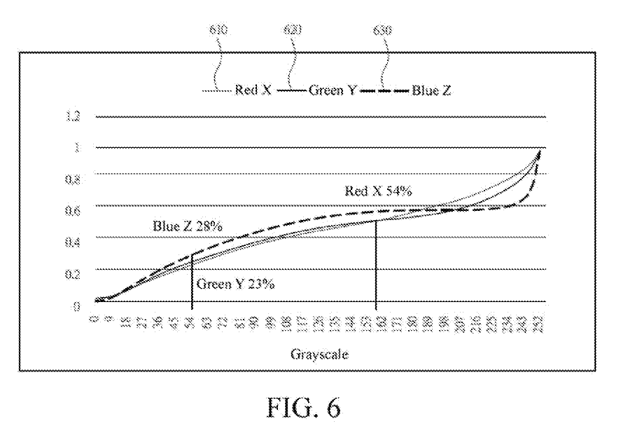

FIG. 2 is a diagram of a relationship between a red color cast and a grayscale of an LCD before color cast adjustment according to an embodiment of this application; FIG. 3 is a diagram of a relationship between a green color cast and a grayscale of an LCD before color cast adjustment according to an embodiment of this application; FIG. 4 is a diagram of a relationship between a blue color cast and a grayscale of an LCD before color cast adjustment according to an embodiment of this application; FIG. 5 is a diagram of a relationship between red X, green Y, and blue Z of red, green, and blue at a front viewing angle and a grayscale of an LCD before color cast adjustment according to an embodiment of this application; and FIG. 6 is a diagram of a relationship between red X, green Y, and blue Z of red, green, and blue at a large viewing angle and a grayscale of an LCD before color cast adjustment according to an embodiment of this application. Referring to FIG. 2, FIG. 3, and FIG. 4, FIG. 2 shows viewing angle color difference change situations of a front viewing angle and a 60-degree horizontal viewing angle under different color mixing conditions of a green system. As for a color cast change of a red hue combination, when a grayscale of a red curve 230 is 160, color mixing of red hues refers to that when green and blue signals are smaller than a red signal or are quite small relative to a red signal, with increases in differences between green and red signals and between blue and red signals, a viewing angle color cast situation is gradually severe. Similarly, as for a color cast change of a green hue combination in FIG. 3, with increases in differences between red and green signals and between blue and green signals, a viewing angle color cast situation is gradually severe. As for a color cast change of a blue hue combination in FIG. 4, with increases in differences between red and blue signals and between green and blue signals, a viewing angle color cast situation is gradually severe.

Refer to FIG. 5, FIG. 6, and the following descriptions for reasons of a color cast. For example, a grayscale of a mixed color at a front viewing angle is red 160, green 50, and blue 50; and grayscale ratios of red X510, green Y520, and blue Z530 to full grayscales red 255, green 255, and blue 255 at a corresponding front viewing angle are 37%, 3%, and 3% in color mixing, and grayscale ratios of red X610, green Y620, and blue Z630 to full grayscales red 255, green 255, and blue 255 at a corresponding large viewing angle are 54%, 23%, and 28% in color mixing. Ratios of red X, green Y, and blue Z in the mixed color at the front viewing angle are different from those of red X, green Y, and blue Z in a mixed color at the large viewing angle. Consequently, luminance ratios of the green Y and the blue Z to the red X at the original front viewing angle are considerably small, and luminance ratios of the green Y and the blue Z to the red X at the large viewing angle are non-neglectable. As a result, a red hue at the large viewing angle is not as bright as a red hue at the front viewing angle, and an obvious color cast occurs.

Referring to the description of FIG. 2, as for color cast changes of various red hue combinations, with increases of differences between green and red signals and between blue and red signals, a viewing angle color cast situation is gradually severe. The reason is, as stated above in FIG. 5 and FIG. 6, that the luminance ratios 37%, 3%, and 3% of red, green, and blue at the front viewing angle are greatly different from the luminance ratios 54%, 23%, and 28% of red, green, and blue at the large viewing angle. In addition, a lower grayscale signal indicates a larger difference between a front viewing angle luminance and a side viewing angle luminance because of rapid saturation and improvement of the viewing angle luminance ratios of grayscale liquid crystal display. An existing international nation-suggested color cast value may have a relatively good liquid crystal display viewing angle observation feature when a color difference<0.02. In this application, by changing an original frame signal to a multi-frame combination, luminance differences between mixed colors of red, green, and blue at the front viewing angle and at the side viewing angle are reduced, to present picture quality of low color cast display.

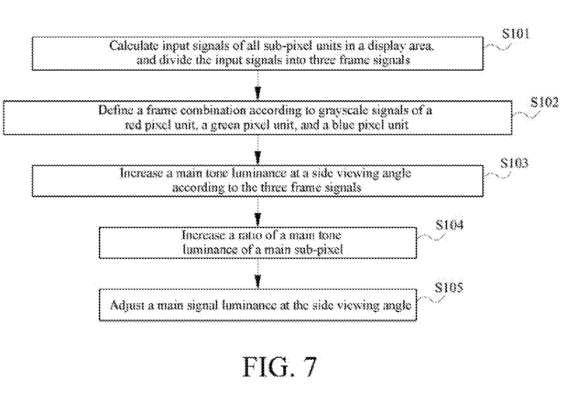

FIG. 7 is a flowchart of a method for driving a display device according to an embodiment of this application. In an embodiment of this application, a method for driving a display device is provided, and includes: calculating input signals of all sub-pixel units in a display area, and dividing the input signals into three frame signals; defining a frame combination according to grayscale signals of a red pixel unit, a green pixel unit, and a blue pixel unit; increasing a main tone luminance at a side viewing angle according to the three frame signals; increasing a ratio of a main tone luminance of a main sub-pixel; and adjusting a main signal luminance at the side viewing angle.

In an embodiment, the input signals of all sub-pixel units in the display area are calculated and are divided into three frame signals, where the three frame signals are respectively a minimum common signal frame, a second single color frame, and a third single color frame.

In an embodiment, regarding the defining a frame combination according to grayscale signals of a red pixel unit, a green pixel unit, and a blue pixel unit, when red hues of the red pixel unit, the green pixel unit, and the blue pixel unit are combined, and a signal of the red pixel unit is greater than a signal of the green pixel unit greater than a signal of the blue pixel unit, a minimum common signal of the red pixel unit, the green pixel unit, and the blue pixel unit is the blue pixel unit. Therefore, the grayscale signals of the red pixel unit, the green pixel unit, and the blue pixel unit are changed into three frame combinations. The three frame combinations are respectively a combination 1 of a first red pixel unit, a first green pixel unit, and a first blue pixel unit, a combination 2 of a second red pixel unit, a second green pixel unit, and a second blue pixel unit, and a combination 3 of a third red pixel unit, a third green pixel unit, and a third blue pixel unit.

In an embodiment, a minimum common signal of the combination 1 of the first red pixel unit, the first green pixel unit, and the first blue pixel unit is the blue pixel unit, that is, the first red pixel unit=the blue pixel unit, the first green pixel unit=the blue pixel unit, and the first blue pixel unit=the blue pixel unit.

In an embodiment, the combination 2 of the second red pixel unit, the second green pixel unit, and the second blue pixel unit is one color of two remaining color signals obtained according to a difference between an original signal and the combination 1, satisfying that the second red pixel unit=the red pixel unit−the blue pixel unit, the second green pixel unit=0, and the second blue pixel unit=0 or the second red pixel unit=0, the second green pixel unit=the green pixel unit−the blue pixel unit, and the second blue pixel unit=0.

In an embodiment, the combination 3 of the third red pixel unit, the third green pixel unit, and the third blue pixel unit is a last remaining signal color, satisfying that the third red pixel unit=0, the third green pixel unit=the green pixel unit−the blue pixel unit, and the third blue pixel unit=0 or the third red pixel unit=the red pixel unit−the blue pixel unit, the third green pixel unit=0, and the third blue pixel unit=0.

In an embodiment, dividing an original frame signal into a combination of three frame signals is performed by dividing a high-voltage sub-pixel signal into two low-voltage combinations.

In an embodiment, the two low-voltage combinations keep a front viewing angle luminance of an original sub-pixel unchanged, and the main tone luminance at the side viewing angle is increased because a sum of two low-voltage side viewing angle luminances is greater relative to an original high-voltage side viewing angle luminance.

In an embodiment, the increased ratio of the main tone luminance of the main sub sub-pixel is a ratio relative to a side viewing angle luminance of an original frame low-voltage sub-pixel.

In an embodiment, one frame is changed into three frame signals in a time sequence, and a time for an original frame signal is long and is a sum of frame times in three division time sequences. Therefore, frame backlight intensities of the three division time sequences need to be enhanced to be three times of an original backlight intensity. That is, the backlight intensity needs to be enhanced to be three times of the original backlight intensity, so as to maintain an overall luminance to be the same as that of the original frame signal.

In an embodiment, main tone colors of the green hue and the blue hue are the same. That is, the sub-pixel unit includes the red pixel unit, the green pixel unit, and the blue pixel unit, may be a combination of any size, and is not limited to a combination of red hues.

In an embodiment, a method for driving a display device is provided, and includes: calculating input signals of all sub-pixel units in a display area, and dividing the input signals into three frame signals; defining a frame combination according to grayscale signals of a red pixel unit, a green pixel unit, and a blue pixel unit; increasing a main tone luminance at a side viewing angle according to the three frame signals; increasing a ratio of a main tone luminance of a main sub-pixel; and adjusting a main signal luminance at the side viewing angle. Regarding the defining a frame combination according to grayscale signals of a red pixel unit, a green pixel unit, and a blue pixel unit, when red hues of the red pixel unit, the green pixel unit, and the blue pixel unit are combined, and a signal of the red pixel unit is greater than a signal of the green pixel unit, and the signal of the green pixel unit is greater than a signal of the blue pixel unit, a minimum common signal of the red pixel unit, the green pixel unit, and the blue pixel unit is the blue pixel unit. Therefore, the grayscale signals of the red pixel unit, the green pixel unit, and the blue pixel unit are changed into three frame combinations. The three frame combinations are respectively a combination 1 of a first red pixel unit, a first green pixel unit, and a first blue pixel unit, a combination 2 of a second red pixel unit, a second green pixel unit, and a second blue pixel unit, and a combination 3 of a third red pixel unit, a third green pixel unit, and a third blue pixel unit. An original sub-pixel signal is changed from the red pixel unit, the green pixel unit, and the blue pixel unit into a combination of three frame signals, and the combination of the three signals is presented in a time sequence, that is, an original frame signal needs to be tripled. At one time, the combination 1 of the first red pixel unit, the first green pixel unit, and the first blue pixel unit is presented. At another time, the combination 2 of the second red pixel unit, the second green pixel unit, and the second blue pixel unit is presented. At still another time, the combination 3 of the third red pixel unit, the third green pixel unit, and the third blue pixel unit is presented.

Referring to FIG. 7, flow S101: Calculate input signals of all sub-pixel units in a display area, and divide the input signals into three frame signals.

Referring to FIG. 7, flow S102: Define a frame combination according to grayscale signals of a red pixel unit, a green pixel unit, and a blue pixel unit.

Referring to FIG. 7, flow S103: Increase a main tone luminance at a side viewing angle according to the three frame signals.

Referring to FIG. 7, flow S104: Increase a ratio of a main tone luminance of a main sub-pixel.

Referring to FIG. 7, flow S105: Adjust a main signal luminance at the side viewing angle.

In an embodiment, a red hue combination of all sub-pixel units R_{i,j}, G_{i,j}, and B_{i,j} (i,j indicates a group of R, G, and B_{i,j} pixel units in a display area) in the display area when, for example, R_{i,j}=100, G_{i,j}=80, and B_{i,j}=40, is calculated. A minimum common signal of R_{i,j}, G_{i,j} and B_{i,j} has a grayscale of 40. Therefore, a grayscale signal of R_{i,j}, G_{i,j}, and B_{i,j} is changed into three combinations, and the three combinations are respectively a combination 1 of R1_{i,j}, G1_{i,j}, and B1_{i,j} a combination 2 of R2_{i,j}, G2_{i,j}, and B2_{i,j}, and a combination 3 of R3_{i,j}, G3_{i,j}, and B3_{i,j}. A minimum common signal of the combination 1 of R1_{i,j}, G1_{i,j}, and B1_{i,j} has a grayscale of 40, that is, R1_{i,j}=40, G1_{i,j}=40, and B1_{i,j}=40. The combination 2 of R2_{i,j}, G2_{i,j}, and B2_{i,j} is one color of a difference between an original signal and a signal of the combination 1. As described above, the combination 2 may satisfy that R2_{i,j}=60, G2_{i,j}=0, and B2_{i,j}=0 or R2_{i,j}=0, G2_{i,j}=40, and B2_{i,j}=0. The combination 3 is a last remaining signal color, that is, R3_{i,j}=0, G3_{i,j}=40, and B3_{i,j}=0 or R3_{i,j}=60, G3_{i,j}=0, and B3_{i,j}=0. Except that the combination 1 is the common signal, a color order of the combinations 2 and 3 may be preferentially presented by any color of the remaining signal.

In an embodiment, the original sub-pixel signal is changed from R_{i,j}, G_{i,j}, and B_{i,j} into a combination of three frame signals, and the combination of the three frame signals is presented in a time sequence. That is, the original frame signal needs to be tripled. At one time, the combination 1 of R1_{i,j}, G1_{i,j}, and B1_{i,j} is presented; at another time, the combination 2 of R2_{i,j}, G2_{i,j}, and B2_{i,j} is presented; and at still another time, the combination 3 of R3_{i,j}, G3_{i,j}, and B3_{i,j} is presented.

Referring to FIG. 5 and FIG. 6, in an embodiment, assuming that front viewing angle luminance ratios of the original frame signal R_{i,j}=100, G_{i,j}=80, and B_{i,j}=40 to a full grayscale signal Gray 255 are SR %, LG %, and MB %, and side viewing angle luminance ratios are correspondingly SR′%, LG′%, and MB′%, where SR>LG>MB, and SR′>LG′>MB′. However, as stated above, a lower grayscale signal indicates a larger difference between a front viewing angle luminance and a side viewing angle luminance. That is, it can be learned that SR/MB is greater than SR′/MB′, and LG/MB is greater than LG′/MB′. Such color mixing makes a luminance of a main luminance signal SR at the front viewing angle greatly different from that of an MB signal, but a luminance of a main luminance signal SR′ at the large viewing angle is slightly different from that of an MB′ signal. Consequently, a viewing angle main tone color is affected and color brightness is decreased. Referring to FIG. 5, SR %=13.3%, LG %=8%, and MB=1.8%. Referring to FIG. 6, SR′%=40%, LG′%=33%, and MB′=17%.

Referring to FIG. 5 and FIG. 6, in an embodiment, a frame combination is used. In the combination 1 of R1_{i,j}, G1_{i,j}, and B1_{i,j}, because signals all have a grayscale of 40, it may be assumed that in FIG. 5, front viewing angle luminance ratios of R1_{i,j}, G1_{i,j}, and B1_{i,j} in the frame are 1.8%, 1.8%, and 1.8%. In FIG. 6, side viewing angle luminance ratios are correspondingly 17%, 17%, and 17%. In FIG. 5, front viewing angle luminance ratios of the combination 2 of R2_{i,j}=60, G2_{i,j}=0, and B2_{i,j}=0 in the frame are 3.8%, 0%, and 0%. In FIG. 6, side viewing angle luminance ratios are correspondingly 26.8%, 0%, and 0%. In FIG. 5, front viewing angle luminance ratios of the combination 3 of R2_{i,j}=0, G2_{i,j}=40, and B2_{i,j}=0 in the frame are 0%, 1.8%, and 0%. In FIG. 6, side viewing angle luminance ratios are correspondingly 0%, 17%, and 0%. Color mixing ratios of the frame 1, the frame 2, and the frame 3 at the side viewing angle, that is, R_{i,j}:G_{i,j}:Bi_{i,j}, are 17%+26.8%+0%/=43.8%, 17%+0%+17%=34%, and 17%+0%+0%=17%. Side viewing angle luminance ratios of the original frame, that is, R_{i,j}:G_{i,j}:G_{i,j}, are 38%, 30%, and 17%. Obviously, a main tone R is increased from 40/17=2.35 in the original frame to 43.8/17=2.57 of the combined frame relative to the luminance ratio of B. A ratio of a main tone pixel is obviously increased compared with other tones. Therefore, a viewing angle is presented in a manner of approaching a main tone from the front viewing angle.

In this application, by means of determining signals of red, green, and blue sub-pixel combinations, red, green, and blue sub-pixel input signals in each group are divided into three frame signals for presentation, and in cooperation with the presentation, a drive frequency of a display needs to be tripled to separately display the three frame signals obtained by means of division. The three frame signals are respectively a minimum common signal frame, a second single color frame, and a third single color frame. The three frame signals obtained by means of division increase a luminance of a main tone at the side viewing angle, and increase a ratio of a main tone of the main sub-pixel relative to the side viewing angle luminance of the original frame low-voltage sub-pixel, so that a color cast situation, affected by the low-voltage sub-pixel, of the main tone at the side viewing angle is improved. Alleviation of a viewing angle color cast problem is ensured, and presentation of a main signal luminance at the side viewing angle is enhanced. A backlight luminance is enhanced to be three times of an original luminance, and therefore, a luminance of display of the red, the green, and the blue sub-pixel combinations and overall image quality remain unchanged.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

The foregoing descriptions are merely preferred embodiments of this application, and are not intended to limit this application in any form. Although this application has been disclosed above through the preferred embodiments, the embodiments are not intended to limit this application. Any person skilled in the art can make some variations or modifications, which are equivalent changes, according to the foregoing disclosed technical content to obtain equivalent embodiments without departing from the scope of the technical solutions of this application. Any simple amendment, equivalent change or modification made to the foregoing embodiments according to the technical essence of this application without departing from the content of the technical solutions of this application shall fall within the scope of the technical solutions of this application.

What is claimed is:

1. A method for driving a display device, comprising:
calculating an input signal of a sub-pixel unit in a display area, and dividing the input signal into three frame signals;
defining a frame combination according to grayscale signals of a first pixel unit, a second pixel unit, and a third pixel unit;
increasing a main tone luminance at a side viewing angle according to the three frame signals;
increasing a ratio of a main tone luminance of a main sub-pixel; and
adjusting a main signal luminance at the side viewing angle.

2. The method for driving a display device according to claim 1, wherein the input signal of the sub-pixel unit in the display area is calculated and is divided into three frame signals.

3. The method for driving a display device according to claim 2, wherein the three frame signals are respectively a minimum common signal frame, a second single color frame, and a third single color frame.

4. The method for driving a display device according to claim 1, wherein regarding the defining a frame combination according to grayscale signals of a first pixel unit, a second pixel unit, and a third pixel unit, when red hues of the first pixel unit, the second pixel unit, and the third pixel unit are combined, and a signal of the first pixel unit is greater than a signal of the second pixel unit, and the signal of the second pixel unit is greater than a signal of the third pixel unit, a minimum common signal of the first pixel unit, the second pixel unit, and the third pixel unit is the third pixel unit.

5. The method for driving a display device according to claim 4, wherein the grayscale signals of the first pixel unit, the second pixel unit, and the third pixel unit are changed into three frame combinations.

6. The method for driving a display device according to claim 5, wherein the three frame combinations are respectively a combination 1 of a first first pixel unit, a first second pixel unit, and a first third pixel unit, a combination 2 of a second first pixel unit, a second second pixel unit, and a second third pixel unit, and a combination 3 of a third first pixel unit, a third second pixel unit, and a third third pixel unit.

7. The method for driving a display device according to claim 6, wherein a minimum common signal of the combination 1 of the first first pixel unit, the first second pixel unit, and the first third pixel unit is the third pixel unit, that is, the first first pixel unit=the third pixel unit, the first second pixel unit=the third pixel unit, and the first third pixel unit=the third pixel unit.

8. The method for driving a display device according to claim 6, wherein the combination 2 of the second first pixel unit, the second second pixel unit, and the second third pixel unit is one color of two remaining color signals obtained according to a difference between an original signal and the combination 1, satisfying that the second first pixel unit=the first pixel unit−the third pixel unit, the second second pixel unit=0, and the second third pixel unit=0.

9. The method for driving a display device according to claim 6, wherein the combination 2 of the second first pixel unit, the second second pixel unit, and the second third pixel unit is one color of two remaining color signals obtained according to a difference between an original signal and the combination 1, satisfying that the second first pixel unit=0, the second second pixel unit=the second pixel unit−the third pixel unit, and the second third pixel unit=0.

10. The method for driving a display device according to claim 6, wherein the combination 3 of the third first pixel unit, the third second pixel unit, and the third third pixel unit is a last remaining signal color, satisfying that the third first pixel unit=0=0, the third second pixel unit=the second pixel unit−the third pixel unit, and the third third pixel unit=0.

11. The method for driving a display device according to claim 6, wherein the combination 3 of the third first pixel unit, the third second pixel unit, and the third third pixel unit is a last remaining signal color, satisfying that the third first pixel unit=the first pixel unit−the third pixel unit, the third second pixel unit=0, and the third third pixel unit=0.

12. The method for driving a display device according to claim 1, wherein dividing an original frame signal into a combination of three frame signals is performed by dividing a high-voltage sub-pixel signal into two low-voltage combinations.

13. The method for driving a display device according to claim 12, wherein the two low-voltage combinations keep a front viewing angle luminance of an original sub-pixel unchanged, and the main tone luminance at the side viewing angle is increased because a sum of two low-voltage side viewing angle luminances is greater relative to an original high-voltage side viewing angle luminance.

14. The method for driving a display device according to claim 1, wherein three frame backlight intensities are three times of an original backlight intensity.

15. The method for driving a display device according to claim 1, wherein main tone colors of a second hue and a third hue are the same.

16. The method for driving a display device according to claim 1, wherein an original sub-pixel signal is changed from the first pixel unit, the second pixel unit, and the third pixel unit into a combination of three frame signals, and the combination of the three signals is presented in a time sequence, that is, an original frame signal needs to be tripled.

17. The method for driving a display device according to claim 16, wherein at one time, the combination 1 of the first first pixel unit, the first second pixel unit, and the first third pixel unit is presented.

18. The method for driving a display device according to claim 17, wherein at another time, the combination 2 of the second first pixel unit, the second second pixel unit, and the second third pixel unit is presented.

19. The method for driving a display device according to claim 18, wherein at still another time, the combination 3 of the third first pixel unit, the third second pixel unit, and the third third pixel unit is presented.

20. A method for driving a display device, comprising:
calculating an input signal of a sub-pixel unit in a display area, and dividing the input signal into three frame signals;
defining a frame combination according to grayscale signals of a first pixel unit, a second pixel unit, and a third pixel unit;
increasing a main tone luminance at a side viewing angle according to the three frame signals;
increasing a ratio of a main tone luminance of a main sub-pixel; and
adjusting a main signal luminance at the side viewing angle, wherein
the increased ratio of the main tone luminance of the main sub sub-pixel is a ratio relative to a side viewing angle luminance of an original frame low-voltage sub-pixel.
